(19) United States
(12) Patent Application Publication
(10) Pub. No.: US 2023/0312389 A1
(43) Pub. Date: Oct. 5, 2023

(54) FLAT GLASS PANE

(71) Applicants: TECHNISCHE UNIVERSITÄT BERGAKADEMIE FREIBURG, Freiburg (DE); 2MH GLAS GMBH, Dietzenbach (DE)

(72) Inventors: Thomas VOLAND, Grossweitzchen (DE); Sabine HÖNIG, Dittmannsdorf (DE); Martin GROSS, Pockau-Lengefeld (DE); Michael HEIDAN, Dietzenbach (DE)

(21) Appl. No.: 18/024,355

(22) PCT Filed: Sep. 2, 2021
(86) PCT No.: PCT/EP2021/074284

§ 371 Date: Mar. 2, 2023

(30) Foreign Application Priority Data
Sep. 3, 2020 (LU) 102045

(51) Int. Cl. C03B 27/04; C03C 21/00; C03C 3/083; C03C 3/091

(52) U.S. Cl. CPC C03B 27/04; C03C 21/002; C03C 3/083; C03C 3/091

(57) ABSTRACT

The invention relates to a flat glass pane made of a base material, which is an alkali-containing silicate glass. The flat glass pane is characterized in that at least one surface layer is enriched with potassium and is depleted of sodium and/or lithium while an inner layer, in particular an inner layer directly adjoining the surface layer, is not enriched with potassium and is not depleted of sodium and/or lithium; and the flat glass pane has a compressive stress up to a compressive stress depth and a tensile stress starting from the compressive stress depth, wherein the tensile stress increases as the depth increases up to a tensile stress maximum arranged in the inner layer, and/or the curve of the tensile stress does not have a linear section depending on the depth, and/or the curve of the tensile stress does not have a section in which the tensile stress is constant depending on the depth.

### CROSS-REFERENCE TO RELATED APPLICATIONS

The present application is a national phase entry under 35 USC § 371 of International Application PCT/EP2021/074284 filed Sep. 2, 2021, claiming priority to and benefit of Luxembourgian Patent Application No. 102045 filed Sep. 3, 2020, the entire disclosure of which is incorporated herein by reference.

### FIELD

The disclosure relates to a flat glass pane which is made of a base material which is an alkali-containing silicate glass, more particularly an alkali metal-alkaline earth metal silicate glass, very particularly a soda-lime glass, or a borosilicate glass, or an aluminosilicate glass.

### BACKGROUND

There are a variety of hardening and strengthening methods known for ideally adapting glass, as a versatile high-tech material, to the particular use. The majority of hardening and strengthening methods either can be employed only at great cost and complexity, and/or are reliant on the use of—usually expensive—specialty glass.

For example, it is known practice to increase the fracture strength of glass through what is called thermal prestressing (colloquially also called thermal hardening or heat treatment). In this case the glass workpiece to be strengthened is heated in a kiln to around 600° C. and then rapidly quenched to room temperature. This quenching causes the surface to solidify, and there is little subsequent change in the external dimensions of the component. Compressive stresses are developed at the surface of the glass workpiece and lead ultimately to a higher fracture strength. Thermal prestressing is employed in particular when producing single-sheet safety glass (toughened safety glass; TSG). The stress profile of single-sheet safety glass exhibits high tensile stresses over the glass thickness in the interior, which in the event of failure of the pane result in a characteristic crazed appearance.

It is also known practice to strengthen glass articles by chemical prestressing. With chemical prestressing, distinctions are made between methods involving high-temperature ion exchange and methods involving low-temperature ion exchange. Only low-temperature ion exchange methods, entailing the replacement of one alkali metal ion by a larger alkali metal ion, have been employed industrially to date. With these methods, a compressive stress zone at the surface of the glass is achieved by an ion exchange which takes place usually in a bath of molten salt, between the glass surface and the salt bath. For example, sodium ions are replaced with potassium ions, producing a compressive stress zone in the glass surface because the potassium ions are larger than the sodium ions. For standard commercial glasses (alkali metal-alkaline earth metal silicate glasses), the treatment time in the salt melt is very long, which is disadvantageous. The time is typically between 8 and 36 hours. The problem of the long process times can be mitigated by the use of expensive specialty glasses in conjunction with the application of complicated, more particularly multistage, treatment methods.

DD 1579 66 discloses a method and an apparatus for strengthening of glass products by ion exchange. The glass products in this case are strengthened by exchange of alkali metal ions between the glass surface and alkali metal salt melts. The strengthening sees hollow glass products with their opening turned downward, or hollow glass products which are rotated or swiveled about a horizontal axis, being irrigated with the salt melt. In this operation, the salt is continuously circulated and passed through perforated plates to generate a cascaded irrigation for the glass products, which are arranged in multiple layers. Unfortunately, for economic viability, this method can be utilized only with the use of comparatively expensive specialty glass.

DE 11 2014 003 344 T5 discloses a chemically hardened glass for flat screens of digital cameras, mobile phones, digital organizers, etc. The chemically hardened glass has a compressive stress layer generated by an ion exchange method, with the glass having a surface roughness of 0.20 nm or higher and with the hydrogen concentration Y in the region to a depth X from an outermost surface of the glass satisfying the equation Y=aX+b where X=from 0.1 to 0.4 (μm). The glass is preheated to a temperature of 100° Celsius and then immersed in molten salt.

### SUMMARY

It is the object of the present disclosure to specify a flat glass pane which has a high strength and which can be produced rapidly and inexpensively in particular in the context of mass production.

The object is achieved by a flat glass pane which is characterized in that
a. at least one surface layer is enriched in potassium and depleted in sodium and/or lithium, while an inner layer, more particularly an inner layer directly bordering the surface layer, is not enriched in potassium and not depleted in sodium and/or lithium, and in that
b. the flat glass pane, down to a compressive stress depth, has a compressive stress and beyond the compressive stress depth has a tensile stress, where the tensile stress rises with increasing depth up to a tensile stress maximum disposed in the inner layer and/or where the profile of the tensile stress as a function of the depth has no linear portion and/or where the profile of the tensile stress as a function of the depth has no portion in which the tensile stress is constant.

In a manner in accordance with the disclosure it has been recognized that through a combination of thermal and chemical hardening, a flat glass pane, composed more particularly of conventional utility glass, can have strength values which are a multiple above the strength values of an identical but untreated flat glass pane.

The disclosure has the very particular advantage that particularly for utility articles in daily life, by virtue of the enhanced fracture strength, the required thickness of the flat glass pane is lower. This has the consequence that in the production of flat glass panes, relative to flat glass panes produced conventionally from the same glass material, glass can be saved. More particularly, therefore, the flat glass panes produced in accordance with the disclosure can have a lower intrinsic weight than flat glass panes produced conventionally from the same glass material.

In a manner in accordance with the disclosure it has been recognized in particular that particularly goods results are achieved if a flat glass pane blank is first produced in the known way and is heated to a primary temperature which lies at most 50 kelvins below and at most 30 kelvins above the Littleton softening point of the glass material. In contrast to the conventional heat treatment, however, the flat glass pane blank is preferably not quenched suddenly to room temperature, but instead to a higher temperature. The heated flat glass pane blank is preferably quenched to a quenching temperature which lies at least 200 kelvins and at most 550 kelvins, more particularly at least 200 kelvins and at most 450 kelvins, below the primary temperature.

Thereafter there may be an ion exchange process whose effect is that ultimately at least a surface layer is enriched in potassium and depleted in sodium and/or lithium, while an inner layer, more particularly an inner layer directly bordering the surface layer, is not enriched in potassium and not depleted in sodium and/or lithium. For the ion exchange process, in accordance with the disclosure, the treatment times required are substantially shorter than in the case of known methods of chemical hardening, for the attainment overall of a substantial increase in the strength values. The ion exchange process may follow—in particular, directly—the quenching process. In particular, it is possible in this way to attain very high strength values, particularly in relation to bending fracture strength, microhardness and scratch resistance, which exceed by a multiple the strength values of an untreated but otherwise identical flat glass pane.

As a result of the type of treatment elucidated above, the flat glass pane of the disclosure has a compressive stress down to a compressive strength depth and beyond the compressive strength depth has a tensile stress, where the tensile stress rises with increasing depth up to a tensile stress maximum disposed in the inner layer and/or where the profile of the tensile stress as a function of the depth does not have a linear portion and/or where the profile of the tensile stress as a function of the depth does not have a portion in which the tensile stress is constant. This distinguishes the flat glass pane of the disclosure very importantly from, for example, flat glass panes which have been treated by a known chemical prestressing method.

The flat glass pane of the disclosure may advantageously be embodied in particular in such a way that the surface layer has a thickness in the range from 0.5 μm to 60 μm, more particularly in the range from 0.5 μm to 30 μm, more particularly in the range from 0.5 μm to 15 μm. Advantageously it has been recognized that very high strength values are achieved if the surface layer has the stated thickness, with the stated thickness of the surface layer being, advantageously, attainable comparatively quickly in spite of the move away from expensive specialty glasses with their costly and inconvenient production.

The flat glass pane may advantageously be embodied in particular in such a way that at least one surface layer is enriched in potassium and depleted in sodium, while an inner layer, more particularly an inner layer directly bordering the surface layer, is not enriched in potassium and not depleted in sodium and/or lithium, or in such a way that at least one surface layer is enriched in potassium and depleted in sodium and/or lithium, while an inner layer, more particularly an inner layer directly bordering the surface layer, is not enriched in potassium and not depleted in lithium.

An especially robust flat glass pane is a pane which has two surface layers, which more particularly are parallel to one another. It is advantageously possible here for each of the two surface layers to be enriched in potassium and depleted in sodium and/or lithium, while an inner layer disposed between the surface layers is not enriched in potassium and not depleted in sodium and/or lithium, and for the flat glass pane on each of both sides to have a compressive stress down to a compressive stress depth and beyond the compressive stress depth a tensile stress, where the tensile stress rises with increasing depth up to a tensile stress maximum disposed in the inner layer and/or where the profile of the tensile stress as a function of the depth does not have a linear portion and/or where the profile of the tensile stress as a function of the depth does not have a portion in which the tensile stress is constant. This may be achieved more particularly by both outer sides of the flat glass pane blank being treated identically.

In this case the flat glass pane may advantageously be embodied more particularly in such a way that each of the two surface layers is enriched in potassium and depleted in sodium, while an inner layer disposed between the surface layers is not enriched in potassium and not depleted in sodium and/or lithium, or in such a way that each of the two surface layers is enriched in potassium and depleted in sodium and/or lithium, while an inner layer disposed between the surface layers is not enriched in potassium and not depleted in lithium.

In particular, in those regions of the flat glass pane in which the surface layers are embodied identically and are parallel to one another, the tensile stress maximum is usually disposed centrically between the surface layers. It is, however, also possible for the flat glass pane to be embodied in such a way that the tensile stress maximum is disposed eccentrically between the surface layers. This may be achieved more particularly through a difference in treatment of the surface layers in the course of production, especially in the course of the strengthening.

More particularly the flat glass pane may be embodied in such a way that toward the side on which a high utility load is anticipated, it has a particularly large stress gradient, while it may have a smaller stress gradient on the side facing away from the anticipated force exposure.

In another configuration, only a first of the two surface layers is enriched in potassium and depleted in sodium and/or lithium, while the other surface layer and an inner layer disposed between the surface layers are not enriched in potassium and not depleted in sodium and/or lithium, where the flat glass pane on each of both sides has a compressive stress down to a compressive stress depth and beyond the compressive stress depth has a tensile stress, where the tensile stress rises with increasing depth up to a tensile stress maximum disposed in the inner layer and/or where the profile of the tensile stress as a function of the depth does not have a linear portion and/or where the profile of the tensile stress as a function of the depth does not have a portion in which the tensile stress is constant. A flat glass pane of this kind may be achieved, for example, by first producing the flat glass pane blank and then subjecting only one side of the flat glass pane blank to further treatment in the manner described above.

The flat glass pane may advantageously have a thickness in the range from 0.03 mm to 22 mm, more particularly in the range from 0.5 mm to 10 mm or from 0.5 mm in the range to 5 mm or in the range from 0.6 mm to 3 mm or in the range from 0.68 mm to 3 mm or of 0.68 mm or in the range from 1.5 mm to 3 mm or in the range from 2 mm to 3 mm. More particularly the flat glass pane may have a thickness of more than 1.5 mm. It has emerged that with thicknesses of these kinds, particularly good strength values are achievable by comparison to identical but untreated flat glass panes.

A feature which can be advantageously exploited in particular is that for a given strength, a flat glass pane of the disclosure can have a significantly lower weight, since a substantially lower thickness and therefore less glass material are required. The production of such a flat glass pane requires less material, and this reduces the materials costs. Furthermore, for a given strength, a weight saving can be made.

The flat glass pane of the disclosure may in particular be embodied such that the strength, more particularly a strength measured in accordance with DIN EN 1288-5, of the flat glass pane is at least 1.5 times, more particularly at least twice or at least three times or at least four times or at least five times, higher than the strength of an identical flat glass pane, more particularly of a flat glass pane of identical shape and thickness and identical base material, that does not have the above-stated special features of the flat glass pane of the disclosure.

The flat glass pane of the disclosure may be produced more particularly in such a way that the surface layer (or surface layers) has (or have) an increased hardness by comparison with the inner layer, and/or such that the surface layer (or the surface layers) has (or have) a Martens hardness, more particularly measured in accordance with DIN EN ISO 14577-1 under a test force of 2N, in the range from 3500 N/mm2 to 3900 N/mm2, more particularly in the range from 3650 N/mm2 to 3850 N/mm2. As already mentioned, the flat glass pane of the disclosure can have such strength values despite the fact that no expensive specialty glasses are used as raw material and despite the fact that no long strengthening process times have to be accepted. Process times of less than an hour are usually sufficient to achieve the abovementioned strength of the flat glass pane.

The flat glass pane may advantageously be embodied in such a way that in the surface layer the fraction of potassium down to a depth in the range from 0.5 μm to 10 μm is greater than the total fraction of sodium and lithium and that the fraction of potassium beyond a depth in the range from 0.5 μm to 10 μm is less than the total fraction of sodium and lithium. A configuration of this kind advantageously exhibits particularly high strength.

Alternatively or additionally it is also possible for the depletion of sodium and/or lithium in the potassium-enriched surface layer down to a depth of at least one quarter of the thickness of the surface layer to be at least 50% (percent by mass).

The glass material of which the flat glass pane is produced is advantageously an alkali metal-alkaline earth metal silicate glass, more particularly a soda-lime glass, or a borosilicate glass. These glasses, and especially alkali metal-alkaline earth metal silicate glass, have the particular advantage that they are obtainable inexpensively. Alkali metal-alkaline earth metal silicate glass has the additional advantage, that it is easy to recycle. In particular there is no problem in disposing of a flat glass pane of the disclosure of this kind in a waste glass receptacle.

The glass material of which the flat glass pane is produced may also be an aluminosilicate glass. Preferably, however, the glass material is not aluminosilicate glass, because such glass is too complicated and in particular too expensive to produce. The glass material preferably has an aluminum oxide fraction of less than 5% (percent by mass) (Al₂O₃<5%), more particularly of less than 4.5% (percent by mass) (Al₂O₃<4.5%).

The glass material may advantageously have a silicon dioxide fraction (SiO₂) of more than 58% (percent by mass) and of less than 85% (percent by mass), more particularly of more than 70% (percent by mass) and of less than 74% (percent by mass). In particular a glass material which is an alkali metal-alkaline earth metal silicate glass may advantageously have a silicon dioxide fraction of more than 70% (percent by mass) and of less than 74% (percent by mass).

Alternatively or additionally it may be advantageous for the glass material to have an alkali metal oxide fraction, more particularly sodium oxide fraction (Na₂O) and/or lithium oxide fraction (Li₂O), in the range from 5% (percent by mass) to 20% (percent by mass), more particularly in the range from 10% (percent by mass) to 14.5% (percent by mass) or in the range from 12% (percent by mass) to 13.5% (percent by mass).

The glass material may (alternatively or additionally) advantageously have a potassium oxide fraction (K₂O) of at most 7% (percent by mass), more particularly of at most 3% (percent by mass) or of at most 1% (percent by mass). In particular the glass material may have a potassium oxide fraction in the range from 0.5% (percent by mass) to 0.9% (percent by mass).

Alternatively or additionally, it may be advantageous for the glass material to have a boron trioxide fraction (B₂O₃) of less than 15% (percent by mass), more particularly of at most 5% (percent by mass).

There are no fundamental restrictions on the way in which the flat glass pane, more particularly the flat glass pane blank, is produced. The flat glass pane may for example be a float glass pane or a rolled glass pane. The flat glass pane blank may also be produced, for example, by drawing from a glass melt.

The flat glass pane of the disclosure may have a planar embodiment. Alternatively the flat glass pane of the disclosure may also be curved in one or two dimensions. In particular, as for example for producing a motor vehicle front pane or a sliding roof pane, it is advantageously possible for a curved flat glass pane blank to be produced first, and to be subsequently treated in the manner outlined above.

The flat glass pane of the disclosure may be embodied or used, for example, as a window pane. Advantageously, for example, it is possible to make advantageous use of the weight, which for a given strength is lower than that of a conventional window pane, in regard to the sizing of the window fittings, for example.

The flat glass pane of the disclosure may be embodied, for example, as a display pane, more particularly for a computer display or mobile phone display or tablet display or television display. Because the disclosure permits the use of inexpensive utility glasses, it is ultimately possible to produce displays more cost-effectively. Accordingly there is particular advantage in particular to electronic devices, especially computers or tablets or mobile phones, which have such a display.

The flat glass pane of the disclosure may be embodied, for example, as a motor vehicle pane, more particularly as a front glass pane or as a sliding roof pane or as a side pane.

The flat glass pane of the disclosure may be used advantageously as a solar glass pane, for the purpose, for example, of covering in the case of thermal solar collectors or in photovoltaics. It is a particular advantage in this context that the flat glass pane of the disclosure can be given a thinner embodiment than flat glass panes of the same base material that do not have the above-stated special features of the flat glass pane of the disclosure, so advantageously increasing the light transmissiveness.

The flat glass pane of the disclosure may be embodied advantageously as a greenhouse pane. The supports of the greenhouse, which support the flat glass panes of the disclosure, can advantageously be given a weaker and hence more cost-effective embodiment, because the flat glass panes of the disclosure, for a given strength, can be given a thinner and hence also more lightweight embodiment than conventional flat glass panes of the same base material. Moreover, the light transmission range can be increased through the possibility of using narrower supports.

The flat glass pane of the disclosure may be employed especially advantageously in connection in particular with the production of vehicles, more particularly motor vehicles; this is the case in particular because with vehicles, through the use of the flat glass pane of the disclosure, it is possible to achieve a low weight in terms of energy consumption and driving properties and, additionally, a high level of safety by virtue of the high strength of the flat glass pane. The flat glass pane may be, for example, a windshield pane or a tailgate pane or a side pane or a roof pane, more particular of a glass roof or of a sliding glass roof or of an opening glass roof.

### BRIEF DESCRIPTION OF THE DRAWING VIEWS

In the drawing, the subject matter of the disclosure is represented illustratively and schematically and is described below with reference to the figures, where elements that are identical or identical in effect are usually provided with the same reference signs, even in different exemplary embodiments. Here:

FIG. 1 shows a schematic representation, not true to scale, of a first component of the stress profile 1 within a flat glass pane of the disclosure,

FIG. 2 shows a schematic representation, not true to scale, of a second component of the stress profile 1 within a flat glass pane of the disclosure,

FIG. 3 shows a first exemplary embodiment of a flat glass pane of the disclosure, and

FIG. 4 shows a second exemplary embodiment of a flat glass pane of the disclosure.

### DETAILED DESCRIPTION

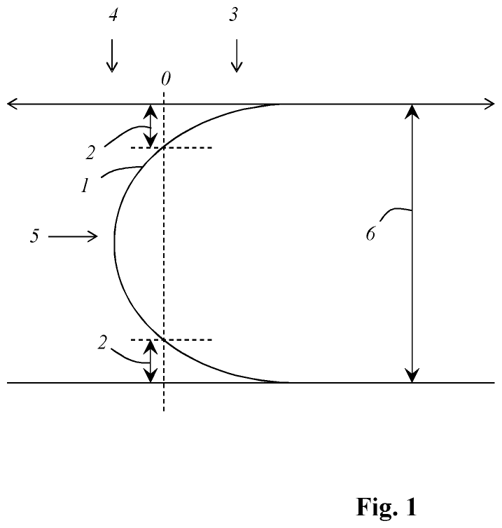

FIG. 1 shows a schematic representation, not true to scale, of a first component of the stress profile 1 within a flat glass pane of the disclosure that has a thickness 6. The first component of the stress profile 1 derives from the fact that initially a flat glass pane blank is produced and is heated to a primary temperature which lies at most 50 kelvins below and at most 30 kelvins above the Littleton softening point of the glass material, and is subsequently quenched to a quenching temperature which lies at least 200 kelvins and at most 550 kelvins, more particularly at least 200 kelvins and at most 450 kelvins, below the primary temperature.

In the diagram the compressive stress 3 increases, starting from the dashed zero line, toward the right, while the tensile stress 4 increases, starting from the dashed zero line, toward the left.

It is apparent that the flat glass pane 7, on each of both sides, has a compressive stress 3 which decreases toward the inside and which transitions into a tensile stress 4, which increases up to the center between the outer sides; the profile of the tensile stress as a function of the depth does not have a linear portion and as a function of the depth does not have a portion in which the tensile stress 4 is constant. In the center between the outer sides, the first component has a maximum 5 of tensile stress 4.

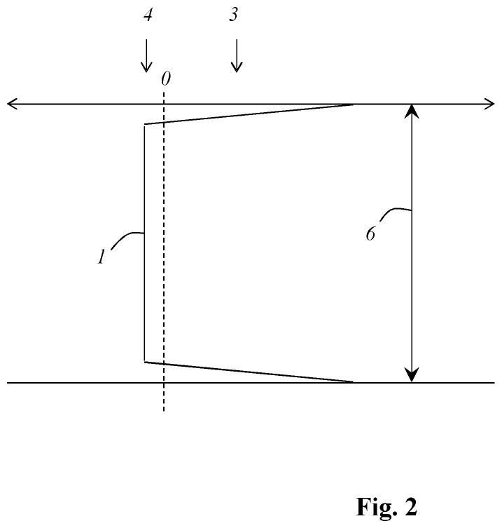

The first component of the stress profile 1 represented in FIG. 1, within the flat glass pane 7, is joined, reinforcing the strength of the flat glass pane 7, by a second component of the stress profile 1 within the flat glass pane, as is represented schematically in FIG. 2.

FIG. 2 shows a schematic representation, not true to scale, of a second component of the stress profile 1 within the flat glass pane, this component deriving from the fact that the two surface layers 10 are enriched in potassium and depleted in sodium and/or lithium, while the inner layer 11 directly bordering the surface layers 10 is not enriched in potassium and not depleted in sodium and/or lithium. It is apparent that the stress profile 1 of the second component in the inner layer 11 is very largely linear.

Both the first component and the second component contribute to the strength of the flat glass pane. The stress profile effective overall is therefore determined jointly by the first component and the second component, and so ultimately on each of both sides, the flat glass pane has a compressive stress 3 down to a compressive stress depth 2 and beyond the compressive stress depth 2 has a tensile stress 4, where the tensile stress 4 rises with increasing depth up to a tensile stress maximum 5 disposed in the inner layer 11 and/or where the profile of the tensile stress 4 as a function of the depth does not have a linear portion and/or where the profile of the tensile stress 4 as a function of the depth does not have a portion in which the tensile stress 4 is constant.

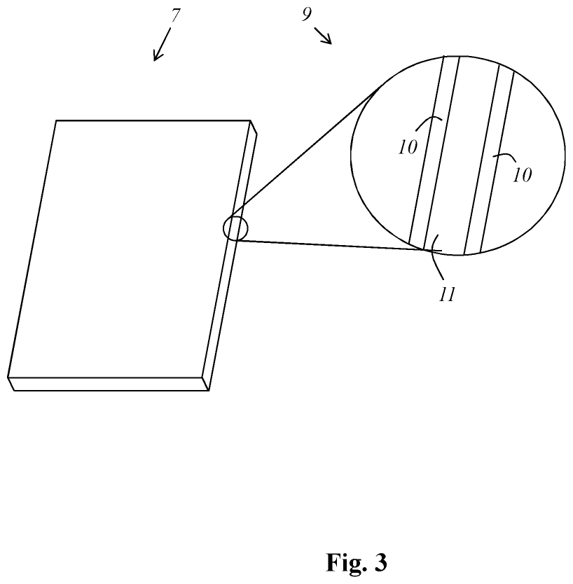

FIG. 3, in a cross-sectional representation, shows a first exemplary embodiment of a flat glass pane 7, which has a planar embodiment. In the enlarged representation 9 of a detail of the flat glass pane 7, the flat glass pane 7 is shown to have, on each of both sides, a surface layer 10 which is enriched in potassium and depleted in sodium and/or lithium, while an inner layer 11, more particularly directly bordering the surface layer 10, is not enriched in potassium and not depleted in sodium and/or lithium. The flat glass pane 7 has a stress profile 1 which results from the simultaneous effect of the two components represented in FIGS. 1 and 2.

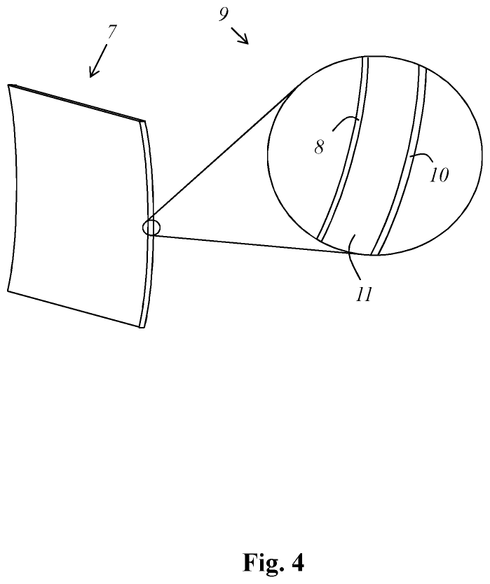

FIG. 4, in a cross-sectional representation, shows a second exemplary embodiment of a flat glass pane 7 of the disclosure, which has a curved embodiment. In the enlarged representation 9 it is shown that the flat glass pane 7 has on one side a surface layer 10 which is enriched in potassium and depleted in sodium and/or lithium, while an inner layer 11, more particularly directly bordering the surface layer 10, and also the other surface layer 12 are not enriched in potassium and not depleted in sodium and/or lithium. In the case of this exemplary embodiment, the flat glass pane 7 exhibits an asymmetric stress profile 1, deriving from two asymmetric components, with the tensile stress maximum being disposed eccentrically between the outer sides of the flat glass pane 7.

### LIST OF REFERENCE SIGNS

1 Stress profile
2 Compressive stress depth
3 Compressive stress
4 Tensile stress
5 Tensile stress maximum
6 Thickness
7 Flat glass pane
8 Other surface layer
9 Enlarged representation
10 Surface layer
11 Inner layer

What is claimed is:

1. A flat glass pane (7) which is made of a base material which is an alkali-containing silicate glass, or is an aluminosilicate glass, characterized in that
a. at least one surface layer (10) is enriched in potassium and depleted in sodium and/or lithium, while an inner layer (11), more particularly an inner layer (11) directly bordering the surface layer (10), is not enriched in potassium and not depleted in sodium and/or lithium, and in that
b. the flat glass pane (7), down to a compressive stress depth (2), has a compressive stress (3) and beyond the compressive stress depth (2) has a tensile stress (4), where the tensile stress (4) rises with increasing depth up to a tensile stress maximum disposed in the inner layer (11) and/or where the profile of the tensile stress (4) as a function of the depth has no linear portion and/or where the profile of the tensile stress (4) as a function of the depth has no portion in which the tensile stress (4) is constant.

2. The flat glass pane (7) as claimed in claim 1, characterized in that the surface layer (10) has a thickness in the range from 0.5 μm to 60 μm, more particularly in the range from 0.5 μm to 30 μm, more particularly in the range from 0.5 μm to 15 μm.

3. The flat glass pane (7) as claimed in claim 1, characterized in that the flat glass pane (7) has two surface layers (10), which more particularly are parallel to one another, and in that
a. each of the two surface layers (10) is enriched in potassium and depleted in sodium and/or lithium, while an inner layer disposed between the surface layers (10) is not enriched in potassium and not depleted in sodium and/or lithium, and in that
b. the flat glass pane (7) on each of both sides, down to a compressive stress depth, has a compressive stress (3) and beyond the compressive stress depth (2) has a tensile stress (4), where the tensile stress (4) rises with increasing depth up to a tensile stress maximum disposed in the inner layer (11) and/or where the profile of the tensile stress (4) as a function of the depth has no linear portion and/or where the profile of the tensile stress (4) as a function of the depth does not have a portion in which the tensile stress (4) is constant.

4. The flat glass pane (7) as claimed in claim 1, characterized in that the tensile stress maximum is disposed centrically between the surface layers (10).

5. The flat glass pane (7) as claimed in claim 1, characterized in that the tensile stress maximum is disposed eccentrically between the surface layers (10).

6. The flat glass pane (7) as claimed in claim 1, characterized in that the flat glass pane (7) has two surface layers (10), which more particularly are parallel to one another, and in that
a. only a first of the two surface layers (10) is enriched in potassium and depleted in sodium and/or lithium, while the other surface layer (8) and an inner layer (11) disposed between the surface layers (10) are not enriched in potassium and not depleted in sodium and/or lithium, and in that
b. the flat glass pane (7), more particularly on each of both sides, down to a compressive stress depth (2) has a compressive stress (3) and beyond the compressive stress depth (2) has a tensile stress (4), where the tensile stress (4) rises with increasing depth up to a tensile stress maximum disposed in the inner layer and/or where the profile of the tensile stress (4) as a function of the depth has no linear portion and/or where the profile of the tensile stress (4) as a function of the depth does not have a portion in which the tensile stress (4) is constant.

7. The flat glass pane (7) as claimed in claim 6, characterized in that the tensile stress maximum is disposed eccentrically between the surface layers (10)

8. The flat glass pane (7) as claimed in claim 1, characterized in that the flat glass pane has a thickness in the range from 0.03 mm to 22 mm, more particularly in the range from 0.5 mm to 10 mm or from 0.5 mm in the range to 5 mm or in the range from 0.6 mm to 3 mm or in the range from 0.68 mm to 3 mm or of 0.68 mm or in the range from 1.5 mm to 3 mm, or in that the flat glass pane has a thickness of more than 1.5 mm.

9. The flat glass pane (7) as claimed in claim 1, characterized in that the strength, more particularly a strength measured in accordance with DIN EN 1288-5, of the flat glass pane is at least 1.5 times, more particularly at least twice or at least three times or at least four times or at least five times, higher than the strength of an identical flat glass pane, more particularly of a flat glass pane of identical shape and size and identical base material, that does not have the features of the characterizing clause of claim 1.

10. The flat glass pane (7) as claimed in claim 1, characterized in that the surface layer (10) has an increased hardness by comparison with the inner layer (11) and/or in that the surface layer (10) has a Martens hardness, more particularly measured in accordance with DIN EN ISO 14577-1 under a test force of 2 N, in the range from 3500 N/mm² to 3900 N/mm², more particularly in the range from 3650 N/mm² to is 3850 N/mm².

11. The flat glass pane (7) as claimed in claim 1, characterized in that in the surface layer (10) the fraction of potassium down to a depth in the range from 0.5 μm to 10 μm is greater than the total fraction of sodium and lithium and in that the fraction of potassium beyond a depth in the range from 0.5 μm to 10 μm is smaller than the total fraction of sodium and lithium.

12. The flat glass pane (7) as claimed in claim 1, characterized in that the depletion of sodium and/or lithium in the potassium-enriched surface layer down to a depth of at least one quarter of the thickness of the surface layer is at least 50% (percent by mass).

13. The flat glass pane as claimed in claim 1, characterized in that the flat glass pane is a float glass pane or a rolled glass pane or drawn glass.

14. The flat glass pane as claimed in claim 1, characterized in that the flat glass pane is embodied as a window pane or as a display pane or as a motor vehicle pane or as a sliding roof pane or as a solar glass pane or as a greenhouse pane.

15. The flat glass pane as claimed in claim 1, characterized in that the glass material is an alkali metal-alkaline earth metal silicate glass, especially a soda-lime glass, or a borosilicate glass.

16. A display, more particularly computer display or mobile phone display, which comprises a flat glass pane as claimed in any of claim 1.

17. An electronic device, more particularly computer or tablet or mobile phone, which comprises a display as claimed in claim 16.

18. A motor vehicle which comprises a flat glass pane as claimed in claim 1.

19. The motor vehicle as claimed in claim 18, characterized in that the flat glass pane is a windshield pane or a tailgate pane or a side pane or a roof pane, more particularly of a glass roof or of a sliding glass roof or of an opening glass roof.
